(19) United States
(12) Patent Application Publication
(10) Pub. No.: US 2004/0108342 A1
(43) Pub. Date: Jun. 10, 2004

(54) One piece push-pull cap for plastic containers

(75) Inventors: Norberto Oscar Gomez, San Luis (AR); Rafael Francisco Berrittella, Buenos Aires (AR)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA

(21) Appl. No.: 10/712,105

(22) Filed: Nov. 14, 2003

Related U.S. Application Data
(60) Provisional application No. 60/430,662, filed on Dec. 4, 2002.

(51) Int. Cl. B67D 3/00

(52) U.S. Cl. 222/521; 222/529

(57) ABSTRACT

A push-pull cap dispenser. The cap comprises a radially surrounding sidewall, a top that radially extends from a substantially central cap opening to the sidewall. The cap further comprises a post adapted for sealingly engaging a receiver opening of a receiver piece, a support structure supporting the post in a spaced position from the cap opening, and an internal cap ring formed on an inner surface of the sidewall of the cap. An outline of the support structure forms a passageway between the cap opening and a hollow space within the cap.

### FIELD OF THE INVENTION

The present invention relates to a dispenser with a push-pull cap.

### BACKGROUND OF THE INVENTION

Conventionally, flexible dispensers of consumer products such as cosmetics, hair gels, condiments, beverages and liquid soaps are often produced with large standing caps and/or with multi-unit closure pieces. Multi-unit closure pieces have utilized a post-and-hole type mechanism. In these closures, closing of a hole in the cap is accomplished by insertion of a post on a base piece that attaches to the bottle. However, the manufacture of multi-unit closure pieces as well as large standing caps is relatively costly. For consumer products with high retail prices, the same methods can be satisfactory when the dispenser costs only a small fraction of the overall price of the packaged product. However, for many other products such as cosmetics, hair gels, condiments, beverages, and liquid soaps, or for packages containing small amounts of product, where dispenser costs become relatively significant, there is an increasing demand to reduce dispenser costs. What is needed then is an improved dispenser and closure that overcomes the shortcomings of prior dispensers.

### SUMMARY OF THE INVENTION

The shortcomings noted above are overcome by a resealable push-pull cap according to the present invention. The cap comprises a radially surrounding sidewall, a top that radially extends from a substantially central cap opening to the sidewall. The cap further comprises a post adapted for sealingly engaging a receiver opening of a receiver piece, a support structure supporting the post in a spaced position from the cap opening, and an internal cap ring formed on an inner surface of the sidewall of the cap. An outline of the support structure forms a passageway between the cap opening and a hollow space within the cap.

### BRIEF DESCRIPTION OF THE DRAWINGS

The foregoing description of the invention will be apparent from the following, more particular description of an embodiment of the invention, as illustrated in the accompanying drawings wherein like reference numbers generally indicate identical, functionally similar, and/or structurally similar elements.

FIG. 1A depicts a close-up bottom view of an embodiment of a cap according to the invention;

FIG. 1B depicts a close-up view of a cross-section of the cap along an A-A line in FIG. 1A;

FIG. 2A depicts another close-up bottom view of the cap;

FIG. 2B depicts a close-up view of a cross-section of the cap along a B-B line in FIG. 2A;

FIG. 3 depicts a close-up view of an embodiment of a neck finish adapted for use with a cap according to the invention;

FIG. 4 depicts a front view of an embodiment of an intermediate article according to the invention, where the article has an open end for being filled with a product;

FIG. 5 depicts a perspective view of an embodiment of a dispenser with a cap according to the invention and a sealed end, where the sealed end runs along the plane of the page;

FIG. 6 depicts a close-up view of a cross-section of a cap according to another embodiment of the invention; and

FIG. 7 depicts a close-up view of another embodiment of a neck finish adapted for use with the cap in FIG. 6.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

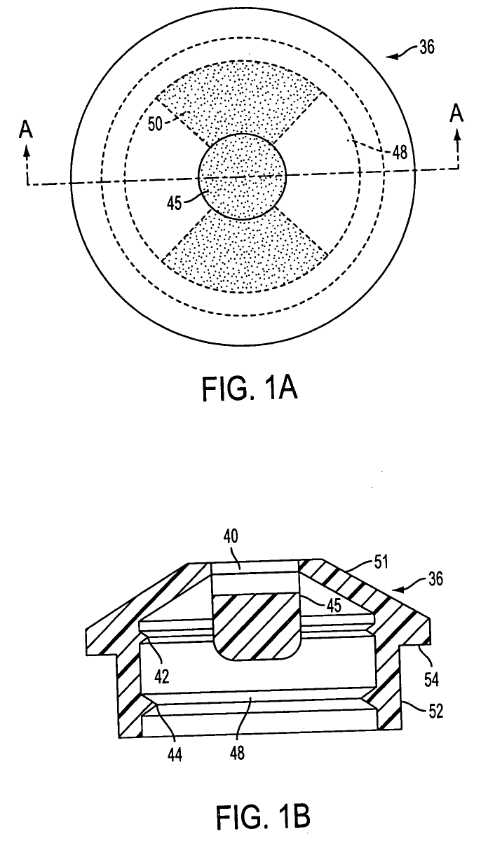

FIG. 1A depicts a close-up bottom view of an embodiment of a cap 36 according to the invention. The cap 36 has an internal support structure 50 to support a post 45 inside the cap 36. The post 45 can be substantially cylindrical. An open space 48 is hollow inside the cap 36 where the internal support structure 50 is absent. The support structure 50 can connect the post 45 to opposite sides of the hollow cap. Alternatively, the support structure 50 can connect the post 45 to only one side of the hollow cap 36 or can connect to two or more sides of the cap 36 that are not necessarily opposite sides. The support structure 50 can be a radiating structure as shown in FIG. 1A. Alternatively, the support structure can be of any shape including, linear, wavy and zigzag shapes.

FIG. 1B depicts a close-up view of a cross-section of the cap along an A-A line in FIG. 1A. The cap 36 is hollow, having an open space 48. The cap 36 has a radially surrounding sidewall 52, a cap ring 44, and a top 51 that radially extends from a substantially central opening 40 to the sidewall 52. In the embodiment shown, the top 51 is a radial ramp 51 and forms a ledge 54 beyond the sidewall 52. The ramp can have a linear slope as shown in FIG. 1B or can have a curved, non-linear slope that can be concave or convex. Alternatively, the top 51 can be any structure other than the depicted radial ramp, including a flat, spherical, square, rectangular or triangular structure. The post 45 is supported by the support structure 50 in a spaced position from the cap opening 40. The outlines of the support structure 50 and the post 45 form a passageway between the cap opening 40 and the hollow space 48 within the cap. This allows a product within a container (e.g., a bottle or tube) to which the cap 36 is attached to flow from inside the container, into the hollow space 48 and out through the opening 40. The support structure can contact an inner surface of the top 51 and/or an inner surface of the sidewall 52. The cap can include a snap ring 42 formed on the internal surface of the cap 36 to snap over a receiver ring of a receiver piece when cap is in a fully closed position. The cap ring 44 is adapted to lock a receiver ring of a receiver piece when the cap 36 is pulled away from the receiver piece. The cap ring 44 can also interact with a neck on the receiver piece to form a seal preventing leakage of product from between the sidewall and receiver piece.

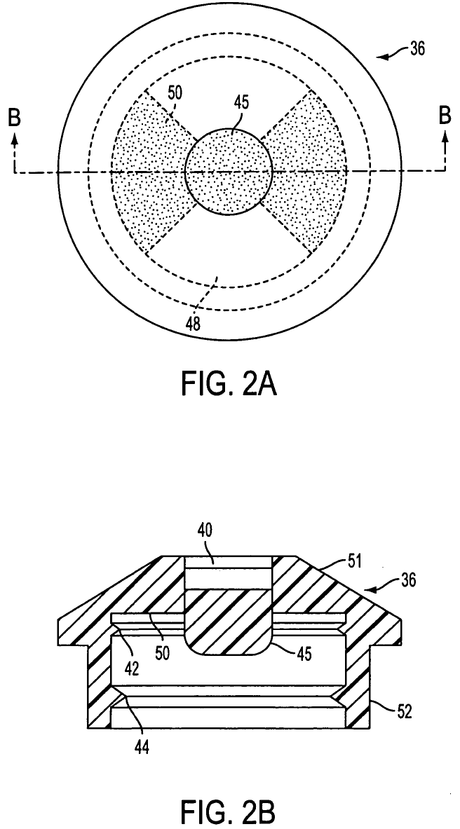

FIG. 2A depicts a close-up bottom view of the cap disclosing a B-B line that crosses the internal support structure 50 of the cap.

FIG. 2B depicts a close-up view of a cross-section of the cap along the B-B line in FIG. 2A. In this view, the support structure 50 contacts the inner surface of the top 51. Alternatively, the support structure can contact the inner surface of the sidewall 52 and/or the inner surface of the top 51.

Exemplary dimensions of the cap 36 are as follows. The height of the cap 36 can be about 4-20 mm, including 8.0 mm. A diameter of the cap 36 at the lowest point of the top 51 can be about 8-35 mm, including 16.0 mm. A diameter of the outer surface of the sidewall 52 of the cap can be about 6-30 mm, including 13.0 mm. A diameter of the inner surface of the sidewall 52 of the cap can be about 5-25 mm, including 11.0 mm. The cap ring 44 can be about 0.3-1.5 mm in thickness, including 0.75 mm. The post 45 can be about 2.0-8.0 mm in width, including 4.0 mm. The snap ring 42 can be about 0.2-0.8 mm in thickness, including 0.4 mm. The ledge of the top 51 over the sidewall 52 can be about 0.7-3.0 mm in radial thickness, including 1.5 mm. The height of sidewall 52 to the lower surface of the ledge of the top 51 can be about 2.0-8.0 mm, including 4.0 mm. The height of the ledge along its outer side boundary can be about 0.0-2.5 mm, including 1.2 mm. These dimensions are exemplary only and can be adjusted to any value as necessary for desired applications and in keeping with the size of the container and the receiver piece to which the cap is attached.

The cap of the invention can be made of a wide variety of materials including plastics. Examples of suitable plastics include nylon; polyolefins such as polyethylene and polypropylene; polyesters; and other thermoplastic or thermosetting materials. The cap can be made by any suitable means, including, but not limited to, injection molding.

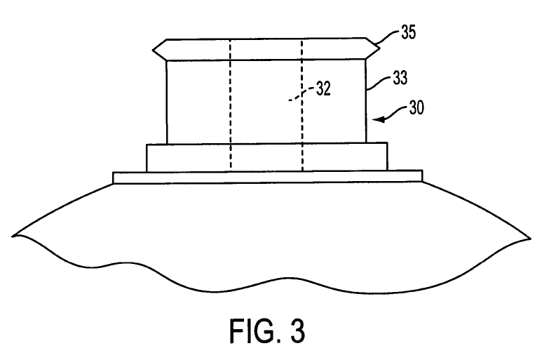

FIG. 3 depicts a close-up view of a receiver piece or neck finish 30 according to an embodiment of the invention. The cap according to an embodiment of the invention can be used on any neck finish, including the one shown in FIG. 3, where the neck finish can be an adaptor added on top of a container (e.g., a bottle or tube), for example, by screwing on, or can be an integrated piece, molded or formed integrally, with the container. The neck finish 30 has an opening 32 that extends completely through the neck finish 30 and a neck ring 35 formed on an outer surface of the sidewall 33 of the neck finish. The opening sealingly engages the complementary post 45 of the cap 36 when the cap 36 pushed into its closed position. The neck ring 35 can be located near the top of the neck finish 30.

The opening 32 can be created by various methods. For example, the opening can be formed by first molding a protrusion that extends out of the opening 32 at the time the neck finish 30 is molded. The protrusion is trimmed subsequently to create the opening 32 to allow an open passage of the enclosed product therethrough when the cap is pulled to its open position. Alternatively, the opening 32 can be created by reaming an opening into neck finish with a closed end. Still another exemplary method of creating the opening 32 is by using the opening 32 in a blow molded container (e.g., a bottle or tube) as a blow hole or needle insertion point to blow-mold the rest of the neck finish. In any of these embodiments, the opening 32 can be reamed subsequently to form a smooth finish.

The finish 30 can be substantially cylindrical. The neck ring 35 of the neck finish can form a sealing surface with a contact surface on an inner surface of the sidewall 52 of the cap. Alternatively, the cap ring 44 of the cap 36 can form a sealing surface with a contact surface on an outer surface of the sidewall 33 of the neck finish.

The neck finish 30 of FIG. 3 can be a piece adapted to connect to a container by for example, threads in a manner similar to other multi-unit closure pieces known in the art. Alternatively, the neck finish 30 can be integrally formed on a container. In either embodiment, the container (e.g., a bottle or tube) can be any suitable plastic, metal or glass container. In exemplary embodiments, the neck finish is integrally molded as part of a plastic container. The plastic container can be made of any suitable plastic material, such as thermoplastic materials including nylon; polyolefins such as polyethylene or polypropylene; polyesters such as polyethylene terephthalate; and polycarbonates. Plastic bottles can be formed by any suitable method known in the art including, but not limited to extrusion, extrusion blow molding, stretch blow molding, injection molding and injection blow molding. When the container is formed by a blow molding process, the opening 32 of the neck finish 30 can be used as the blow hole through which an air injecting needle is inserted.

Exemplary dimensions of a finish 30 that can be used with the cap 36 having the dimensions described above are as follows: The height of the finish can be about 3-15 mm, including 6.6 mm. A diameter of the finish including the neck ring 35 can be about 5-22 mm, including 11 mm. A diameter of the outer surface of the sidewall 33 of the neck finish 30 can be about 4-20 mm, including 10.4 mm. The height of the neck ring 35 can be about 1-5 mm, including 2.0 mm. The diameter of the opening 32 can be about 2-10 mm, including 4 mm and 9 mm.

In the embodiments of the cap and the receiver piece described above and below, only one post and one opening for the cap and one opening for the neck piece have been depicted. However, the cap can have more than one post and/or more than one opening to increase the flow of product. Further, independently of the cap, the bottom portion can have more than one opening to increase the flow of product.

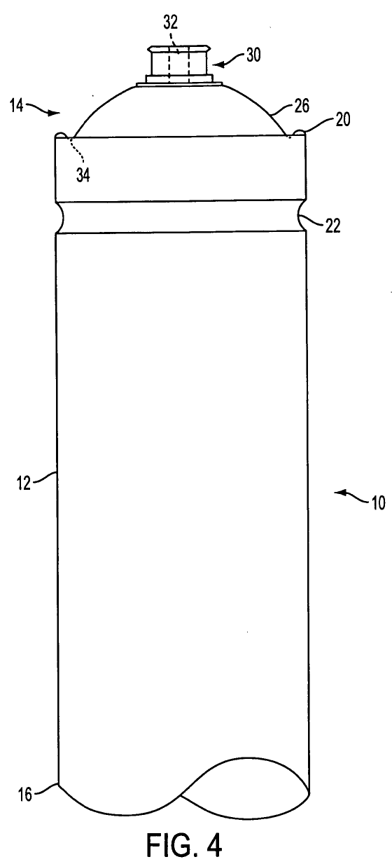

FIG. 4 depicts a front view of an exemplary embodiment of an intermediate article/body 10 with a neck finish 30 to which a cap according to the invention can be attached. Such an article and a container made therefrom is described in International Application No. PCT/US01/45602 filed Nov. 2, 2001, International Application No. PCT/US03/13715 filed on May 2, 2003, U.S. Provisional Application No. 60/246,778 filed Nov. 8, 2000, and U.S. Provisional Application No. 60/318,155 filed Sep. 7, 2001, each of which is hereby incorporated in its entirety by reference. The article 10 has an open end 16 through which a container (e.g., a bottle or tube) prepared from the article 10 can be filled with a product. The article 10 can have a one-piece or multiple-piece construction and can be uniformly made of monolayer plastic material, such as LDPE, or a multilayer plastic layer. The article 10 can be used to package a wide variety of liquid, viscous or solid products including, for example, beverages, yogurt, sauce, pudding, lotions, soaps in liquid or gel form, and powdered solids. The entire article 10 or the parts of it can be made by utilizing a suitable molding process, for example extrusion blow molding.

Turning first to the structural aspects of the article 10, it has a flexible sidewall 12 with opposite ends 14 and 16. A first end 14 is the dispensing end of the article 10. A finish 30 according to the present invention can be integrally formed ion the dispensing end 14. A second end 16, which is opposite from the dispensing end 14, is open and can be utilized to fill the article 10. The second and 16 can thereafter be heat sealed to form a seam, for example a straight line, planar seam.

The sidewall 12, as formed, is a radially surrounding sidewall of any type, including substantially tubular sidewall that forms a circular, rectangular, triangular, oval and any other geometric shapes in its cross-section. The sidewall 12 is flexible and enables the second end 16 to be flattened into a planar seam to seal the tube. The sidewall 12 adjacent the dispensing end 14 terminates in a circular standing ring 20 on which the dispenser can be freely stood with the seam on the second end 16 facing upwardly. A circumferential inset groove 22 can be formed in the sidewall 12 a short distance away from the standing ring 20 to reinforce the adjacent section of the sidewall 12. In addition, a label can be applied to the sidewall 12.

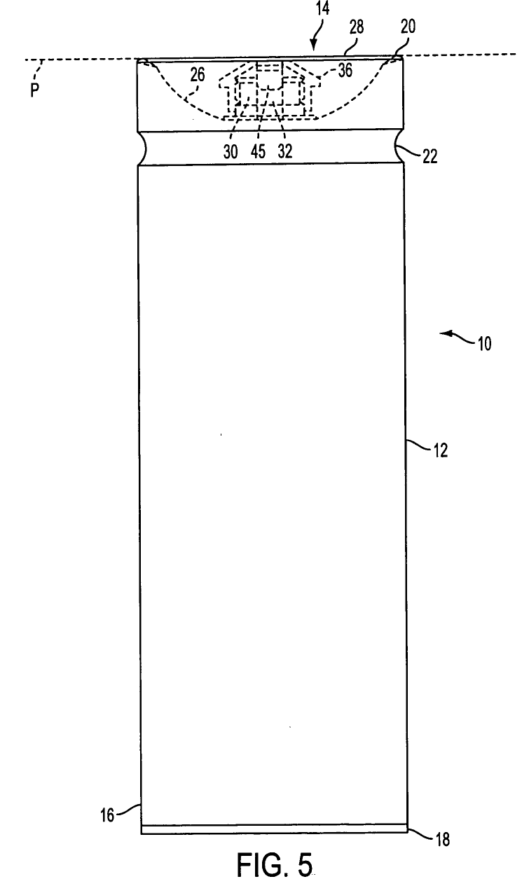

The first end 14 of the article 10 has a dome 26 extending from the standing ring 20 and closing the dispensing end 14. The dome can be of any geometrical shape, including spherical, cubical, and pyramidical shapes, that creates a convex section in an outwardly projecting position of the dome 26 and can be easily inverted into a corresponding concave section in an inwardly projecting position of the dome 26 by flipping the section about a hinged connection 34 between the standing ring 20 and the dome 26. (See FIG. 5.) Once the dome 26 is placed in either one of the inwardly or outwardly projecting positions, the dome 26 can retain its position absent an application of external forces to flip the dome 26 to the other position.

The flexible sidewall 12 and the first end 14 can be formed as one piece by using various molding techniques, including injection molding and blow molding techniques, without integrating separately manufactured parts. For example, when using extrusion blow molding techniques, a molten tube of thermoplastic material can be extruded relative to a pair of open blow mold halves. The blow mold halves can close about the molten tube and cooperate to provide a cavity into which the molten tube is blown to form the intermediate body/article 10. In using any of various molding techniques, a neck finish (receiver piece) 30 with a protrusion over a substantially central opening 32 in the neck finish can be formed simultaneously with the molding of the sidewall 12 and the dome 26. In this embodiment, the protrusion is trimmed subsequently to create the opening 32. Alternatively, the finish 30 can be formed with a closed, flat end that is reamed subsequently to form the opening 32. In either of these embodiments, air for the blow molding process can be applied through the open end 16. Alternatively, the opening 32 can be formed with the article by utilizing the opening 32 as the blow hole.

During the molding of the sidewall 12, labels can be bonded to the sidewall 12 by using the mold. Alternatively, labels can be attached after the molding. The dome 26 may first be molded in an outwardly projecting position and subsequently flipped into an inwardly projecting position before insertion of contents into the filling end 16.

After the molding step, the sidewall 12 can be trimmed along a cut line of the second end 16 of the intermediate article 10 to remove excess scrap material beyond the cut line. If the intermediate article 10 is to be filled with a food or drink product, a tamper evident covering can be bonded to the standing ring 20 to prevent contamination of the dispensing end 14 before filling the intermediate article 10.

FIG. 5 depicts a dispenser with the second end 16 flattened into a planar seam 18. The dome 26 is depicted in FIG. 5 provided in an inwardly projecting position within the sidewall 12 and below an imaginary plane “P” extending through the standing ring 20. Thus, the dome 26 as illustrated in FIG. 5 can be said to be in a storage position since the dome 26 does not interfere with the free standing of the dispenser 10 on the standing ring 20 and permits a tamper indicating covering 28 to be bonded to the standing ring 20 as best illustrated in FIG. 5. The covering 28 can be a foil or other sheet-like covering and can be utilized to prevent contamination or unrecognizable tampering of the first end 14 of the dispenser 10 before its removal by a user.

After the step of molding the intermediate article, the dispenser 10 is made by filling a product into the intermediate article through an open end 16 and sealing the open end to form the closed planar seam 18.

When using the dispenser 10, the covering 28, if there is one, is first removed. The flexible sidewall 12 is then grasped and squeezed resulting in the dome 26 flipping from an inwardly projecting position to an outwardly projecting position. This elevates the neck finish 30 and the cover 36 to a readily accessible location. As is also shown in FIG. 5, when the cap 36 is in the closed position, the post 45 of the cap 36 is engaged in the opening 32 to form a seal. From the outwardly projecting position of the dome 26, the cap 36 can be pulled to an open position. The cap ring 44 can come into contact with the receiver ring 35 of the neck finish 30 to inhibit the cap 36 from being removed from the neck finish 30. In the open position, the post 45 is removed from the opening 32 so that an enclosed product can pass through the neck 30, into the hollow space 48 of the cap 36, and out through the opening 40 for dispensing. A desired quantity of the enclosed product can be dispensed by squeezing the flexible sidewall 12. After extracting a desired quantity of the enclosed product, the cap 36 can be pushed into the closed position and the dome 26 can be pushed back into the inwardly projecting position for using the standing ring or the dome 26 can be left in the outwardly projecting position.

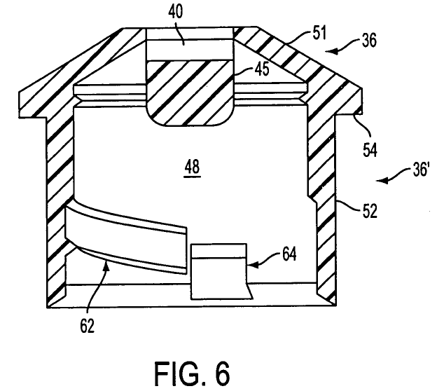

FIG. 6 depicts another embodiment of a cap 36′ according to the invention. The cap 36′ of this embodiment differs only in the portion where it attaches to the neck finish by having a threaded fit rather than a snap-fit. The cap 36′ is hollow, having an open space 48. The cap 36′ has a radially surrounding sidewall 52, a thread 62, and a top 51 that radially extends from a substantially central opening 40 to the sidewall 52. In the embodiment shown, the top 51 is a radial ramp and forms a ledge 54 beyond the sidewall 52. The radial ramp can have a linear slope as shown in FIG. 6 or can have a curved, non-linear slope that can be concave or convex. Alternatively the top 51 can be any structure other than the depicted radial ramp, including a flat, spherical, square, rectangular or trianguar structure. The post 45 is supported by the support structure in a spaced position from the cap opening 40. The outlines of the support structure and the post 45 form a passageway between the cap opening 40 and the hollow space 48 within the cap. This can allow a product within a container (e.g., a bottle or tube) to which the cap 36′ is attached to flow from inside the container, into the hollow space 48 and out through the opening 40. The support structure can contact an inner surface of the top 51 and/or an inner surface of the sidewall 52. The thread 62 of the cap 36′ slidingly engages a ramp of a neck finish to slide the cap up or down the ramp. The thread 62 can be of any length to allow an appropriate turn of the cap around the neck finish, including any fractional turns, e.g., ¼, ⅓, ½ turn, and one or more turns. A rotation stop 64 can be formed on an inner surface of the cap 36′ to prevent the cap from rotating up or down beyond a certain limit.

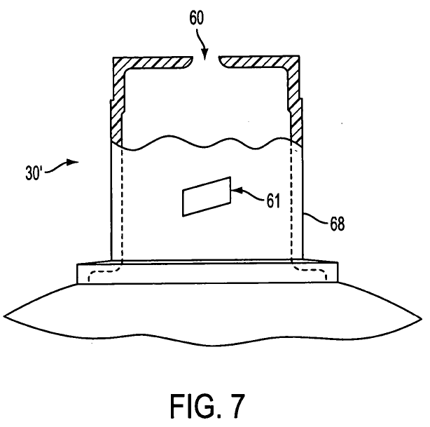

FIG. 7 depicts a close-up view of an embodiment of receiver piece or neck finish 30′ adapted for use with the cap 36′ of FIG. 6. The neck finish 30′ has a ramp 61 formed on the outer surface of the neck finish for engagement with a thread 62 of the cap 36′ so that as the cap turns, the thread turns and climb up or down the ramp 61. The neck finish 30′ has an opening 60 that sealingly engages the post 45 of the cap when the cap is turned to its closing position. The opening 60 can be created by any methods including the ones discussed in relation to creating the opening 32 of the neck finish 30′ of FIG. 3.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A hollow cap comprising:
a radially surrounding sidewall;
a top that radially extends from a substantially central cap opening to an end of the top at the sidewall of the cap;
a post adapted for sealingly engaging a receiver opening of a receiver piece;
a support structure supporting the post in a spaced position from the cap opening; and
an internal cap ring formed on an inner surface of the sidewall of the cap, where an outline of the support structure forms a passageway between the cap opening and a hollow space within the cap.

2. The cap of claim 1, wherein the support structure contacts an inner surface of the top.

3. The cap of claim 1, wherein the support structure connects the post to opposite sides of the cap.

4. The cap of claim 1, wherein the cap ring forms a sealing surface with a contact surface of the receiver piece.

5. The cap of claim 1, wherein the top forms a ledge over the sidewall.

6. The cap of claim 1, wherein the top is a radial ramp that radially ramps down from the substantially central cap opening to the end of the top at the sidewall.

7. The cap of claim 6, wherein the radial ramp is concave, convex or linear.

8. A closure arrangement comprising:
a hollow cap comprising a radially surrounding sidewall, a top that radially extends from a substantially central cap opening to an end of the top at the sidewall, a post, a support structure supporting the post in a spaced position from the cap opening, and an internal cap ring formed on an inner surface of the sidewall of the cap, an outline of the support structure forming a passageway between the cap opening and a hollow space within the cap; and
a receiver piece comprising a radially surrounding sidewall, a substantially central receiver opening for sealingly receiving the post of the cap, a receiver ring formed around an outer surface of the sidewall of the receiver piece, where the receiver opening extends completely through the receiver piece and the receiver ring is adapted to lock the cap ring when the cap is pulled away from the receiver piece.

9. The arrangement of claim 8, wherein the support structure contacts an inner surface of the top.

10. The arrangement of claim 8, wherein the support structure connects the post to opposite sides of the cap.

11. The arrangement of claim 8, wherein the cap ring forms a sealing surface with a contact surface of the receiver piece.

12. The arrangement of claim 8, wherein the receiver ring forms a sealing surface with a contact surface of the cap.

13. The arrangement of claim 8, wherein the cap further comprises a snap ring formed on the inner surface of the sidewall of the cap to snap over the receiver ring when the cap is in a fully closed position.

14. The arrangement of claim 8, wherein the top forms a ledge over the sidewall.

15. The arrangement of claim 8, wherein the top is a radial ramp that radially ramps down from the substantially central cap opening to the end of the top at the sidewall.

16. The arrangement at claim 15, wherein the radial ramp is linear, concave or convex.

17. A container comprising the arrangement of claim 8.

18. The container of claim 17, comprising a neck comprising the receiver piece integrally molded therewith.

19. A dispenser comprising:
a radially surrounding dispenser sidewall having a first end, where the dispenser sidewall is molded as one piece, the first end comprising:
a hollow cap comprising a radially surrounding sidewall, a top that radially extends from a substantially central cap opening to an end of the top at the sidewall of the cap, a post, a support structure supporting the post in position spaced from the cap opening, and an internal cap ring formed on an inner surface of the sidewall of the cap, an outline of the support structure forming a passageway between the cap opening and a hollow space within the cap; and
a receiver piece comprising a radially surrounding sidewall, substantially central receiver opening for sealingly receiving the post of the cap, a receiver ring formed around an outer surface of the sidewall of the receiver piece, where the receiver opening extends completely through the receiver piece and the receiver ring is adapted to lock with the cap ring when the cap is pulled away from the receiver piece.

20. The dispenser of claim 19, wherein the support structure contacts an inner surface of the top.

21. The dispenser of claim 19, wherein the support structure connects the post to opposite sides of the cap.

22. The dispenser of claim 19, wherein the cap ring forms a sealing surface with a contact surface of the receiver piece.

23. The dispenser of claim 19, wherein the receiver ring forms a sealing surface with a contact surface of the cap.

24. The dispenser of claim 19, wherein the cap further comprises a snap ring formed on the inner surface of the sidewall of the cap to snap over the receiver ring when the cap is in a fully closed position.

25. The cap of claim 19, wherein the top forms a ledge over the sidewall.

26. The dispenser of claim 19, wherein the top is a radial ramp that radially ramps down from the substantially central cap opening to the end of the top at the sidewall.

27. The cap of claim 26, wherein the radial ramp is concave, convex or linear.

28. The dispenser of claim 19, wherein the first end of the dispenser sidewall further comprises a dome between the dispenser sidewall and the receiver piece.

29. The dispenser of claim 28, wherein the first end of the dispenser sidewall further comprises a hinged interconnection formed between the dome and the dispenser sidewall.

30. A method of making a dispenser comprising the steps of:
molding in a mold a body as one piece;
the body comprising:
a radially surrounding dispenser sidewall having a first end that comprises:
a receiver piece comprising a radially surrounding sidewall and a receiver ring formed around an outer surface of the sidewall of the receiver piece;
forming a substantially central receiver opening on the receiver piece, where the opening extends completely through the receiver piece; and
placing on top of the receiver piece a hollow cap comprising a radially surrounding sidewall, a top that radially extends from a substantially central cap opening to an end of the top at the sidewall of the cap, a post for sealingly engaging the receiver opening, a support structure supporting the post in a spaced position from the cap opening, and an internal cap ring formed on an inner surface of the sidewall of the cap, where an outline of the support structure forms a passageway between the cap opening and a hollow space within the cap and the receiver ring is adapted to lock the cap ring when the cap is pulled away from the receiver piece.

31. The method of claim 30, wherein the support structure contacts an inner surface of the top.

32. The method of claim 30, wherein the support structure connects the post to opposite sides of the cap.

33. The method of claim 30, wherein the cap ring forms a sealing surface with a contact surface of the receiver piece.

34. The method of claim 30, wherein the receiver ring forms a sealing surface with a contact surface of the cap.

35. The method of claim 30, wherein the cap further comprises a snap ring formed on the inner surface of the sidewall of the cap to snap over the receiver ring when the cap is in a fully closed position.

36. The method of claim 30, wherein the first end of the dispenser sidewall further comprises a dome between the dispenser sidewall and the receiver piece.

37. The method of claim 36, wherein the first end of the dispenser sidewall further comprises a hinged interconnection formed between the dome and the dispenser sidewall.

38. The method of claim 30, wherein the receiver piece comprises a protrusion and the forming a substantially central receiver opening comprises trimming the protrusion to create the substantially central receiver opening.

39. The method of claim 30, further comprising the steps of:
filling the body with a product via a second end of the body, the second end being open initially; and
sealing the second end with a seam to create a filled dispenser.

40. The method of claim 30, wherein the top forms a ledge over the sidewall.

41. The method of claim 30, wherein the top is a radial ramp that radially ramps down from the substantially central cap opening to the end of the top at the sidewall.

42. The method of claim 38, wherein the radial ramp forms is concave, convex or linear.

43. A hollow cap comprising:
a radially surrounding sidewall;
a top that radially extends from a substantially central cap opening to an end of the top at the sidewall of the cap;
a post adapted for sealingly engaging a receiver opening of a receiver piece;
a support structure supporting the post in a spaced position from the cap opening; and
a thread adapted for slidingly engaging a ramp of the receiver piece to slide the cap up or down the ramp.

44. The cap of claim 43, wherein the support structure contacts an inner surface of the top.

45. The cap of claim 43, wherein the support structure connects the post to opposite sides of the cap.

46. A closure arrangement comprising:
a hollow cap comprising a radially surrounding sidewall, a top that radially extends from a substantially central cap opening to an end of the top at the sidewall, a post, a support structure supporting the post in a spaced position from the cap opening, and a thread, an outline of the support structure forming a passageway between the cap opening and a hollow space within the cap; and
a receiver piece comprising a radially surrounding sidewall, a substantially central receiver opening for sealingly receiving the post of the cap, and a ramp for slidingly engaging the thread of the cap to slide the cap up or down the ramp, where the receiver opening extends completely through the receiver piece.

47. The arrangement of claim 46, wherein the support structure contacts an inner surface of the top.

48. The arrangement of claim 46, wherein the support structure connects the post to opposite sides of the cap.
